(19) United States
(12) Patent Application Publication
(10) Pub. No.: US 2006/0201203 A1
(43) Pub. Date: Sep. 14, 2006

(54) Method for preparing a photocatalytic coating integated into glazing heat treatment

(75) Inventors: Laurent Labrousse, Saint Prim (FR); Nicolas Nadaud, Gentilly (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/565,001

(22) PCT Filed: Jul. 21, 2004
(86) PCT No.: PCT/FR04/01927

§ 371 Date: Jan. 19, 2006

(30) Foreign Application Priority Data
Jul. 23, 2003 (FR) 0308975

(51) Int. Cl. C03C 17/00; B32B 17/06

(52) U.S. Cl. 65/60.5; 65/60.2; 428/432

(57) ABSTRACT

The invention relates to a method for preparing a material exhibiting photocatalytic properties and comprising at least partially crystallised titanium oxide, in particular in the form of anatase at temperatures higher than 600° C. Said invention also relates to a glass sheet whose at least one face is coated with a material which contains titanium oxide and is thermally treatable at a temperature higher than 600° C. by such methods as quenching and/or bowing, but preserving the photocatalytic activity and required optical properties thereof for a clean-surface glazing. The invention also relates to a monolithic foliated glazing which is simple or multilayer and comprises said glass sheet, and to the use of said glazing for a building, a transport vehicle, as an ordinary glazing, for interior use, street furniture, mirror, a display system screen and photovolatic glazing.

The present invention relates to glazing provided with a coating exhibiting photocatalytic properties, of the type comprising at least partially crystallized titanium oxide, especially in anatase form.

Several techniques are known for forming such a coating, especially on a glass sheet, with a view to obtaining a product of high optical quality. Available techniques include, for example, a sole-gel process, consisting in depositing a titanium dioxide precursor in solution followed by heating so as to form the dioxide crystallized in anatase form, a pyrolysis process, especially CVD (Chemical Vapor Deposition), in which titanium dioxide precursors in a vapor phase are brought into contact with the hot substrate, optionally during cooling, in particular the atmosphere face of a float output glass.

Cathode sputtering, known from patent WO 97/10186, proves also to be particularly advantageous from the standpoint of industrial scale-up. This is a vacuum technique that makes it possible, in particular, for the thicknesses and the stoichiometry of the deposited layers to be very finely adjusted. It is generally enhanced by a magnetic field for greater efficiency. It may be reactive sputtering, in which case it starts with an essentially metallic target, here based on titanium (optionally alloyed with another metal or with silicon), and the sputtering takes place in an oxidizing atmosphere, generally an Ar/O₂ mixture. It may also be nonreactive sputtering, in which case it starts with a ceramic target already in the oxidized form of titanium (optionally alloyed). The titanium dioxide produced by cathode sputtering is generally amorphous and poorly crystallized, and it has to be heated subsequently for it to crystallize in the photocatalytically active form.

Application WO 02/24971 discloses the deposition on glass of partially crystallized anatase titanium dioxide by cathode sputtering at a relatively high working pressure of at least 2 Pa; in a first variant, during the deposition the substrate is for example at 220-250° C., a conventional annealing operation at about 400° C. then being carried out if required; in a second variant, the deposition is carried out on the substrate at room temperature, and then the coated substrate is heated to 550° C. at most, for a few hours.

In the current state of knowledge, if particular properties requiring an annealing, bending, toughening or other heat treatment at above 600° C., or even up to 700° C. in certain cases, are required for glazing coated with photocatalytic TiO₂, the expert would inevitably deposit the TiO₂ or its precursors after this heat treatment and would then activate or react the precursors by applying a more moderate temperature. In particular, it is considered that temperatures above 600° C. favor crystallization of TiO₂ in the rutile form, which is photocatalytically less active than the anatase form.

Now, the inventors have succeeded in obtaining high photocatalytic activity and high optical quality by crystallizing the titanium dioxide at the temperatures of conventional glass heat treatments, thereby achieving this crystallization by the single toughening or other heat treatment and avoiding an additional subsequent heating operation at a more moderate temperature.

For this purpose, the subject of the invention is a method of preparing a material exhibiting photocatalytic properties comprising at least partially crystallized titanium oxide, especially in anatase form, characterized in that it employs temperatures in excess of 600° C. As a result, there is better integration of this method into various industrial processes, which are simplified by the elimination of a specific crystallization operation at a relatively low temperature. The duration of these processes is correspondingly shortened thereby. There are fewer devices required, since the heating means accomplish two functions simultaneously. Finally the cost of these processes is reduced.

According to preferred embodiments and/or embodiments that particularly prompted the invention:
the method employs temperatures in excess of 630° C.;
it entails a toughening and/or bending treatment carried out on glazing (that is to say for example at temperatures possibly up to 700° C.).

So as to provide excellent results in the illustrative examples below, the method of the invention comprises the deposition of a titanium oxide coating on a first face of a first transparent or semitransparent substrate of the glass or glass-ceramic type which, optionally, has been provided beforehand with one or more functional multilayers and/or functional layers, the nature of which will be described in detail later.

According to other advantageous features of the method of the invention:
it comprises the deposition, on the second face of said first transparent or semitransparent substrate or on a second face belonging to a second transparent or semitransparent substrate, of one or more functional multilayers and/or functional layers, the nature of which will also be explained in detail below (the method of the invention therefore makes it possible to obtain transparent or semitransparent products exhibiting mechanical properties obtained by heat treatment at relatively high temperature, and may have the broadest range of combined functionalities);
said employment of temperatures in excess of 600° C. is after the deposition on said first and second faces (however, any other variant in which these temperatures are not applied after deposition on the second face is not excluded from the invention, as long as these temperatures are applied after deposition on the first face; in other words, the coating product on the second face cannot be subjected to temperatures in excess of 600° C., for example by carrying out the deposition on the second face after use of these temperatures or, in the case in which the second face belongs to a second substrate, the latter can be associated with the first substrate—in double-glazing or laminated glazing—only after this has been subjected to these temperatures—combination of a first substrate made of toughened glass with a second substrate made of nontoughened glass. Otherwise, again according to the invention, the products deposited on the first and second faces are heated simultaneously to more than 600° C., which may be advantageous and economical, the second substrate itself, if it exists, then also being thermally treated);
the deposition on said first and second faces is carried out by cathode sputtering and advantageously, in this case, in line and simultaneously or almost simultaneously, along a substantially identical direction and an opposite sense (especially intended is the use of a magnetically enhanced cathode sputtering installation of the type commonly called “sputter up and down”, in which the first and second faces are horizontal and directed upward and downward respectively, so that they are contacted by sputtering cones of vertical average direction, downward in the case of TiO₂ and upward in the case of the thermal-control multilayer, respectively). However, any other orientation of the first and second faces is not excluded from the invention, namely vertical, or inclined to a greater or lesser extent.

The subject of the invention is also a glass sheet, at least one face of which bears a coating of a material comprising titanium oxide, characterized in that it is capable of undergoing or has undergone a heat treatment at above 600° C., such as a toughening and/or bending operation, while still preserving the photocatalytic activity and the optical quality that are required for antisoiling glazing.

Firstly, the heat treatment at above 600° C. does not affect the product to such an extent that it makes it unsuitable for use as antisoiling glazing; it has even been observed, not without surprise, that the photo-catalytic activity is comparable, or even superior in certain cases, to that obtained after heat treatments according to the teaching of the abovementioned application WO 02/24971 (for example in annealing at 500° C. for one hour).

Nor is the use of temperatures above 600° C. incompatible with high optical quality, by which it is essentially meant that there are no defects visible to the eye: haze, spots or pitting, cracks. Advantageously, from an industrial standpoint, the mean colorimetric variation ΔE in reflection on the coating side induced by the heat treatment is at most 2.8, preferably at most 2.3; this expresses the fact that the colorimetric response in reflection of the end product is close to that of the coating product before heat treatment. AE is calculated by the equation:
ΔE=(ΔL²+Δa*²+Δb*²)^{1/2}
in which Δ expresses the change in a parameter induced by the heating: L, the lightness; a* and b*, the chromaticity coordinates (in the (L,a*,b*) colorimetry system, positive values of a* go toward red, negative values of a* go toward green, positive values of b* go toward yellow and negative values of b* go toward blue; the region of a* and b* values close to 0 is achromatic).

Other subjects of the invention consist of:
single or multiple, laminated, monolithic glazing, which includes a glass sheet as described above;
single or multiple, laminated, monolithic glazing, at least a first face of at least a first constituent glass sheet of which bears a coating of a material exhibiting photocatalytic properties, obtained in accordance with the method of the invention.

According to other preferred features of this glazing:
beneath the coating of a material exhibiting photocatalytic properties, said first face bears one or more functional multilayers and/or functional layers, including at least one layer forming a barrier to the migration of alkali metals from the glass liable to result from the application of temperatures in excess of 600° C. (for this barrier layer, SiO₂, Si₃N₄ and AlN deposited by magnetron sputtering, SiOC deposited by CVD, etc. are known; for other functionalities, the multilayers and layers provided below for said second face may be used, to the exclusion of hydrophilic and hydrophobic layers that are intended to be brought into contact with the atmosphere);
the second face of said first glass sheet or a second face belonging to a second constituent glass sheet bears one or more functional multilayers and/or functional layers chosen from a thermal control, such as solar-control, or low-emissivity multilayer, a multilayer or a layer with an optical functionality, such as antireflection, light radiation filtration, coloration or scattering, a layer of an antisoiling photocatalytic material especially of the type with high activity, a hydrophilic layer, a hydrophobic layer, a network of conductive threads or a conductive layer especially for heating, or an antenna or antistatic layer, these being taken individually or in combination.

Another subject of the invention is the application of this glazing as “self-cleaning”, especially antifogging, anticondensation and antisoiling glazing, especially architectural glazing of the double-glazing type, vehicle glazing of the windshield, rear window, side window and wing mirror type for automobiles, windows for trains, aircraft and ships, utilitarian glazing, such as aquarium glass, shop window glass and greenhouse glass, interior furnishings, urban furniture (bus shelters, billboards, etc.), mirrors, screens for display systems of the computer, television and telephone type, electrically controllable glazing, such as electrochromic glazing of the liquid-crystal or electroluminescent type, or photovoltaic glazing.

The invention is illustrated below by means of examples.

### EXAMPLE 1

In this example, the transformation of amorphous TiO₂ obtained by magnetron sputtering into its active form by, on the one hand, an industrial toughening operation and, on the other hand, an annealing operation for one hour at 500° C. are compared.

The photocatalytic activity after the two treatments was determined by means of the stearic acid photo-degradation/infrared transmission test or SAT for short, this test being described in application WO 00/75087.

A 60 nm thick layer of SiOC was deposited on three specimens of 4 mm-thick clear soda-lime silicate glass by chemical vapor deposition (CVD) as described in application WO 01/32578, and a 100 nm thick SiO₂ layer was deposited on three other specimens by magnetron sputtering.

TiO₂ coatings of varying thickness were deposited on the six specimens by magnetron sputtering at a working pressure of 26·10⁻³ mbar, and then the photocatalytic activity of the coatings was determined as indicated above after the two aforementioned heat treatments.

The results are given in Table I below.

TABLE I

| | TiO₂ | | SAT after | SAT after 1 h |
|---|---|---|---|---|
| Trial | thickness | | toughening | at 500° C. |
| No. | (nm) | Sublayer | (10⁻³ cm⁻¹ min⁻¹) | (10⁻³ cm⁻¹ min⁻¹) |
| 1 | 25 | SiO₂ | 7.9 | 4.7 |
| 2 | 25 | SiOC | 10.2 | 2.3 |
| 3 | 39 | SiO₂ | 11.9 | 6.2 |
| 4 | 39 | SiOC | 3.4 | 7.3 |
| 5 | 146 | SiO₂ | 10.5 | 1.2 |
| 6 | 19 | SiOC | 6 | 3.7 |

Contrary to what was expected, not only does the industrial toughening operation not reduce the photocatalytic activity unacceptably, but the latter is at least comparable to that resulting from TiO₂ activation treatments known in the prior art, as represented in particular by WO 02/24971 already mentioned. In fact, the activity is no longer weak after toughening only in Trial 4.

Consequently, the TiO₂ prepared here could be toughened from the photocatalytic activity standpoint, even by employing standard thicknesses of sublayers acting as barriers to the diffusion of alkali metals from the glass.

### EXAMPLE 2

The above trials 1, 3 and 5, and also trials 7 and 8 characterized by respective thicknesses of the photocatalytic coating obtained of 27 and 19 nm (with the same SiO₂ barrier sublayer and the same TiO₂ formation conditions as in trials 1, 3 and 5), involved the measurement of the mean colorimetric change ΔE in reflection on the coating side induced by the industrial toughening operation. The meaning of the various parameters in the (L,a*,b*) colorimetry system and the equation for calculating ΔE from ΔL, Δa* and Δb* are as described above.

The results are given in Table II below.

TABLE II

| Trial No. | ΔL | Δa* | Δb* | ΔE |
|---|---|---|---|---|
| 1 | 1.02 | 0.23 | −0.46 | 1.14 |
| 3 | −0.08 | 0.77 | −2.10 | 2.24 |
| 5 | 1.40 | −0.47 | 0.91 | 1.73 |
| 7 | 1.70 | −0.57 | 0.04 | 1.79 |
| 8 | 1.39 | −1.15 | −2.09 | 2.76 |

The relatively small mean colorimetric changes, or even in some cases ideally changes of less than 2, express a small color change in reflection on the photocatalytic coating side after all the coating has undergone an industrial toughening operation. This avoids the undesirable production of toughened products that undergo an excessively large colorimetric change as a result of the toughening operation. It becomes easier to predict, from before the toughening operation, what the final color will be.

### EXAMPLE 3

This example relates to a double glazing unit consisting of two 4 mm thick glass sheets between which there is a 15 mm thick air cavity. In this example and the following ones, the face 2 of the double glazing unit, i.e. that face in contact with the air cavity of the glass sheet intended to be installed closest to the external atmosphere (and not that intended to be on the inside of a building), is coated with a thermal control multilayer deposited by magnetron sputtering. This process is particularly practical for depositing layers of the most varied type, by varying and precisely controlling the thicknesses thereof, on an industrial scale.

Here, this multilayer was a low-emissivity multilayer, that is to say one that reflects thermal infrared radiation (for wavelengths of the order of 10 μm) and capable of keeping heat inside a building for example.

The combination of the thermal control multilayer on face 2 with a multilayer that included a photocatalytic TiO₂ layer and an SiO₂ sublayer acting as barrier to the diffusion of alkali metals, deposited by magnetron sputtering on face 1, intended to be in contact with the external atmosphere, was studied from the optical standpoint.

Hereafter, X and Y denote, respectively, the low-emissivity multilayers differing from that of Example 2 of application EP 0 718 250 A2 only by changing the thickness of the layer (2) to 25 nm, and layer (2) to 19 nm and layer (3) to 29 nm, respectively.

The following four glazing compositions defined below only by the glass sheet on the outside, were tested:
3a: 4 mm glass/36 nm Si₃N₄/X;
3b: 18 nm TiO₂/150 nm SiO₂/4 mm glass/X
3c: 18 nm TiO₂/75 nm SiO₂/9 nm Si₃N₄/63 nm SiO₂/4 mm glass/X;
3d: (the same photocatalytic multilayer as in 3b) . . . /4 mm glass/Y.

In this example and in Examples 4-7 below, all the multilayers were subjected to an industrial toughening operation. The optical characteristics of the glazing were determined in transmission and in reflection on the “interior” side of the building (i.e. face 4 of the double glazing unit, of which only faces 1 and 2 were functionalized as indicated above), in reflection on the “exterior” side of the building (face 1: glass or TiO₂) (the light transmission and light reflection T_{L} and R_{L} in percent, chromaticity coordinates a* and b* in transmission and in reflection on both faces of the glazing, as mentioned above). The results are given in the following tables.

TABLE III.1
transmission

| Glazing No. | T_{L} | a* | b* |
|---|---|---|---|
| 3a | 78.9 | −2.3 | 0.8 |
| 3b | 75.0 | −2.0 | 2.0 |
| 3c | 76.8 | −2.4 | 1.2 |
| 3d | 74.1 | −2.5 | 2.4 |

TABLE III.2
reflection (interior side)

| Glazing No. | R_{L} | a* | b* |
|---|---|---|---|
| 3a | 12.2 | 0.2 | −2.6 |
| 3b | 15.7 | −1.1 | −5.3 |
| 3c | 14.1 | 0.2 | −3.6 |
| 3d | 16.0 | 0.5 | −6.0 |

TABLE III.3
reflection (exterior side)

| Glazing No. | R_{L} | a* | b* |
|---|---|---|---|
| 3a | 11.6 | 0.0 | −5.8 |
| 3b | 16.0 | −1.0 | −8.1 |
| 3c | 13.9 | 0.4 | −6.4 |
| 3d | 15.8 | 0.6 | −8.7 |

Comparison between glazing 3a and glazing 3b indicates in what way the addition of the photocatalytic coating is liable to disturb the optical properties of the glazing: thus, a reduction in T_{L}, a substantial increase in R_{L} on both faces, and an increase in chromaticity in reflection on both faces of the glazing toward the blue-green (negative a* and b* values) are observed.

Compared with glazing 3b, in glazing 3c some of the lost T_{L} is recovered and the two R_{L} values again advantageously approach those of glazing 3a, as do its colorimetric values in reflection.

### EXAMPLE 4

The methodology of Example 3 was adopted for the following glazing (the multilayers on face 2 reflect the solar radiation, corresponding to average wavelengths of the order of 1 μm). In this example, X and Y denote, respectively, the solar-protection multilayer sold by Saint-Gobain Glass France under the registered trade mark SGG Coollite ST®108 and the multilayer obtained by increasing the outermost layer thicknesses of the latter by 3.7, on the proximal side of the glass substrate, and by ⅔ on the distal side, respectively:
4a: 6 mm glass/X;
4b: 18 mm TiO₂/150 nm SiO₂/6 mm glass/X;
4c: 18 nm TiO₂/50 nm SiO₂/12 nm Si₃N₄/71 nm SiO₂/6 mm glass/X;
4d: the same photocatalytic multilayer as in 4b/6 mm glass/Y.

In this example and the following ones, the glazing units were composed of two 6 mm thick glass sheets between which there was a 12 mm thick air cavity.

The results are given in the three tables below.

TABLE IV.1
transmission

| Glazing No. | T_{L} | a* | b* |
|---|---|---|---|
| 4a | 6.6 | 2.1 | 6.8 |
| 4b | 6.4 | 2.2 | 7.2 |
| 4c | 6.4 | 2.2 | 6.7 |
| 4d | 8.5 | 1.6 | 6.6 |

TABLE IV.2
reflection (interior side)

| Glazing No. | R_{L} | a* | b* |
|---|---|---|---|
| 4a | 34.4 | −2.4 | 13.1 |
| 4b | 34.4 | −2.4 | 13.1 |
| 4c | 34.4 | −2.4 | 13.1 |
| 4d | 28.2 | −1.0 | 13.8 |

TABLE IV.3
reflection (exterior side)

| Glazing No. | R_{L} | a* | b* |
|---|---|---|---|
| 4a | 39.4 | −3.0 | 1.9 |
| 4b | 41.5 | −3.0 | 0.4 |
| 4c | 41.3 | −3.1 | 1.8 |
| 4d | 39.4 | −3.1 | 1.9 |

Here, the T_{L} is little affected by the addition of TiO₂, which also provides a slight reduction in yellow in reflection on the TiO₂ (4b)/glass (4a) exterior side.

The modification of the solar-protection multilayer (4d) results in an increase in T_{L} and a substantial reduction in R_{L} on the interior side, accompanied by a slight increase in yellow in reflection.

### EXAMPLE 5

Example 4 was repeated, X and Y denoting here, respectively, the solar-protection multilayer sold by Saint-Gobain Glass France under the registered trade mark SGG Coollite ST®120 and the multilayer differing from the latter only by increasing the thickness of the proximal layer of the glass substrate by a factor of 2:
5a: 6 mm glass/X;
5b: 18 nm TiO₂/150 nm SiO₂/6 mm glass/X;
5c: 18 nm TiO₂/68 nm SiO₂/10 nm Si₃N₄/69 nm SiO₂/6 mm glass/X;

5d: idem 5b/6 mm glass/Y.

TABLE V.1
transmission

| Glazing No. | T_{L} | a* | b* |
|---|---|---|---|
| 5a | 17.2 | −2.3 | −3.9 |
| 5b | 16.5 | −2.2 | −3.2 |
| 5c | 16.8 | −2.3 | −3.9 |
| 5d | 17.0 | −2.2 | −3.9 |

TABLE V.2
reflection (interior side)

| Glazing No. | R_{L} | a* | b* |
|---|---|---|---|
| 5a | 29.5 | −0.3 | 13.7 |
| 5b | 29.7 | −0.3 | 13.4 |
| 5c | 29.6 | −0.3 | 13.6 |
| 5d | 31.1 | −0.5 | 12.8 |

TABLE V.3
reflection (exterior side)

| Glazing No. | R_{L} | a* | b* |
|---|---|---|---|
| 5a | 32.5 | −1.5 | −1.1 |
| 5b | 34.9 | −1.6 | −2.4 |
| 5c | 33.8 | −1.3 | −1.0 |
| 5d | 32.4 | −1.5 | −1.0 |

5c in relation to 5b shows, compared with 5a, a partial recovery of the lost T_{L} and of the two R_{L} values and, notably, a complete recovery of the color in reflection on both sides, even with a slightly better coloration neutrality.

In 5d, the recovered T_{L} is increased, the reflection on the interior side is slightly higher (less good) whereas the reflection on the exterior side (TiO₂) is reduced to an even lower (better) level than the R_{L} of 5a on the exterior (glass) side.

### EXAMPLE 6

The previous example was repeated for the following glazing units, in which X and Y denote, respectively the solar-protection multilayer sold by Saint-Gobain Glass France under the registered trade mark SGG Coollite ST®136 and the multilayer differing from the latter only by the thickness of the proximal and distal layers of the glass substrate increased by a factor of 1.7 and 0.774, respectively:
6a: 6 mm glass/X;
6b: 18 nm TiO₂/150 nm SiO₂/6 mm verre/X;
6c: 18 nm TiO₂/66 nm SiO₂/10 nm Si₃N₄/57 nm SiO₂/6 mm glass/X;

6d: the same photocatalytic multilayer as in 6b/6 mm glass/Y.

TABLE VI.1
transmission

| Glazing No. | T_{L} | a* | b* |
|---|---|---|---|
| 6a | 32.6 | −2.4 | −3.4 |
| 6b | 31.1 | −2.2 | −2.6 |
| 6c | 31.7 | −2.4 | −3.2 |
| 6d | 30.7 | −2.1 | −2.1 |

TABLE VI.2
reflection (interior side)

| Glazing No. | R_{L} | a* | b* |
|---|---|---|---|
| 6a | 22.7 | −0.4 | 8.1 |
| 6b | 23.3 | −0.6 | 7.1 |
| 6c | 23.1 | −0.5 | 7.7 |
| 6d | 27.4 | −1.1 | 3.6 |

TABLE VI.3
reflection (exterior side)

| Glazing No. | R_{L} | a* | b* |
|---|---|---|---|
| 6a | 21.4 | −1.2 | −6.4 |
| 6b | 24.8 | −1.6 | −7.5 |
| 6c | 23.4 | −1.1 | −6.3 |
| 6d | 21.1 | −1.4 | −6.2 |

The comparison between 6a and 6b is characterized by an increase in R_{L} on the exterior side of the glazing and, to a lesser extent, by an increase in chromaticity of the second relative to the first.

By optimizing the photocatalytic multilayer 6c, some of the lost T_{L} is recovered and the R_{L} on the exterior side is again substantially reduced, while recovering the color in reflection on the same face (with even a more neutral colorimetric response than 6a).

By modifying the solar-protection multilayer 6d, the R_{L} on the exterior (TiO₂) side is lowered to an even lower level than that of 6a on the glass side, and the yellow component in reflection on the interior side of the glazing is reduced relative to that of the other three glazing units.

### EXAMPLE 7

The previous example was repeated with the following glazing units, in which X and Y denote, respectively, the solar-protection multilayer sold by Saint-Gobain Glass France under the registered trade mark SGG Coollite ST®150 and the multilayer differing from the latter only by the elimination of the proximal layer of the glass substrate and by increasing the thickness of the intermediate layer by a factor of 1.5 and the distal layer by a factor of 0.68:
7a: 6 mm glass/X;
7b: 18 nm TiO₂/150 nm SiO₂/6 mm glass/X;
7c: 18 nm TiO₂/64 nm SiO₂/13 nm Si₃N₄/50 nm SiO₂/6 mm glass/X;

7d: the same photocatalytic multilayer as in 7b/6 mm glass/Y.

TABLE VII.1
transmission

| Glazing No. | T_{L} | a* | b* |
|---|---|---|---|
| 7a | 45.7 | −2.4 | −1.3 |
| 7b | 43.5 | −2.1 | −0.3 |
| 7c | 44.4 | −2.3 | −1 |
| 7d | 33.4 | −2.1 | −0.4 |

TABLE VII.2
reflection (interior side)

| Glazing No. | R_{L} | a* | b* |
|---|---|---|---|
| 7a | 21.4 | −1.0 | 1.5 |
| 7b | 22.6 | −1.3 | 0.4 |
| 7c | 22.1 | −1.1 | 1.1 |
| 7d | 26.0 | −1.1 | 2.1 |

TABLE VII.3
reflection (exterior side)

| Glazing No. | R_{L} | a* | b* |
|---|---|---|---|
| 7a | 14.3 | −1.1 | −7.2 |
| 7b | 18.4 | −1.8 | −8.8 |
| 7c | 16.7 | −1.1 | −7.3 |
| 7d | 17.5 | −1.2 | −6.8 |

These show in particular the near recovery of color in reflection on the exterior side of 7c in relation to that of 7a.

### EXAMPLE 8

This example relates to what is called a “four seasons” multilayer, providing both solar-protection and low emissivity, sold by Saint-Gobain Glass France under the registered trade mark Planistar®. Unlike the thermal control multilayers of the previous examples, but similar to those of the following examples the latter is not subjected to the industrial toughening operation, which is therefore carried out, if required, before the multilayer is deposited, on the glass sheet optionally provided with its TiO₂ coating and the barrier sublayer.

The following glazing was tested:
8a: 6 mm glass/Planistar®;
8b: 18 nm TiO₂/150 nm SiO₂/6 mm glass/Planistar®;

8c: 18 nm TiO₂/68 nm SiO₂/8 nm Si₃N₄/58 nm SiO₂/6 mm glass/Planistar®.

TABLE VIII.1
transmission

| Glazing No. | T_{L} | a* | b* |
|---|---|---|---|
| 8a | 67.7 | −4.7 | 3.4 |
| 8b | 64.4 | −4.3 | 4.6 |
| 8c | 65.6 | −4.6 | 3.7 |

TABLE VIII.2
reflection (interior side)

| Glazing No. | R_{L} | a* | b* |
|---|---|---|---|
| 8a | 13.7 | 0.4 | −3.0 |
| 8b | 15.5 | −2.9 | −6.0 |
| 8c | 15.4 | −0.3 | −2.9 |

TABLE VIII.3
reflection (exterior side)

| Glazing No. | T_{L} | a* | b* |
|---|---|---|---|
| 8a | 11.1 | −2.6 | −2.6 |
| 8b | 16.3 | −1.2 | −4.2 |
| 8c | 13.9 | −2.3 | −3.2 |

Glazing 8c, compared with 8b, restores the color, in reflection on the interior side, of 8a and also, on the exterior side, where the reduction in R_{L} compared with 8b is moreover slightly more significant.

### EXAMPLE 9

The thermal control multilayer was a solar-protection multilayer sold by Saint-Gobain Glass France under the registered trade mark SKN®154. The following glazing was tested:
9a: 6 mm glass/SKN®154;
9b: 18 nm TiO₂/150 nm SiO₂/6 mm glass idem 9a;

9c: 18 nm TiO₂/68 nm SiO₂/8 nm Si₃N₄/58 nm SiO₂/6 mm glass/idem 9a.

TABLE IX.1
transmission

| Glazing No. | T_{L} | a* | b* |
|---|---|---|---|
| 9a | 49.3 | −7.9 | 2.7 |
| 9b | 47.0 | −7.5 | 3.5 |
| 9c | 47.8 | −7.7 | 3.0 |

TABLE IX.2
reflection (interior side)

| Glazing No. | R_{L} | a* | b* |
|---|---|---|---|
| 9a | 23.0 | 0.7 | 5.9 |
| 9b | 24.4 | −0.2 | 4.9 |
| 9c | 24.0 | 0.1 | 5.4 |

TABLE IX.3
reflection (exterior side)

| Glazing No. | R_{L} | a* | b* |
|---|---|---|---|
| 9a | 19.2 | −3.1 | −9.2 |
| 9b | 22.8 | −3.2 | −9.9 |
| 9c | 21.6 | −2.9 | −9.3 |

Here it is particularly manifest, on the exterior side, that for 9c an R_{L} intermediate of that of the other two coated glasses is obtained and also a blue component of the color in reflection that is almost the same level as in the absence of TiO₂ (9a).

### EXAMPLE 10

The multilayer SKN®165B, again sold by the Applicant, was tested, and more particularly the following glazing:
10a: 6 mm glass/SKN®165B;
10b: 18 nm TiO₂/150 nm SiO₂/6 mm glass idem 10a;

10c: 18 nm TiO₂/69 nm SiO₂/9 nm Si₃N₄/49 nm SiO₂/6 mm glass/ . . . idem 10a.

TABLE X.1
transmission

| Glazing No. | R_{L} | a* | b* |
|---|---|---|---|
| 10a | 60.1 | −7.5 | 4.2 |
| 10b | 57.3 | −7.2 | 5.1 |
| 10c | 58.5 | −7.5 | 4.7 |

TABLE X.2
reflection (interior side)

| Glazing No. | R_{L} | a* | b* |
|---|---|---|---|
| 10a | 19 | 2.1 | 1.3 |
| 10b | 21.1 | 0.7 | 0.3 |
| 10c | 20.2 | 1.5 | 0.8 |

TABLE X.3
reflection (exterior side)

| Glazing No. | R_{L} | a* | b* |
|---|---|---|---|
| 10a | 15.7 | −2.2 | −9.8 |
| 10b | 19.6 | −2.6 | −10.5 |
| 10c | 17.9 | −1.9 | −10.1 |

### EXAMPLE 11

A 50 nm thick SiOC layer acting as barrier to the migration of alkali metals and covered with a 15 nm thick photocatalytic TiO₂ layer was formed by a CVD process on a glass sheet, reproducing Example 5 of patent EP 0 850 204 B1.

The photocatalytic activity, determined by photodegradation of stearic acid followed by infrared transmission, as previously, was 9·10⁻³ cm⁻¹min⁻¹ and, after industrial toughening, 7·10⁻³ cm⁻¹min⁻¹. This corresponds with the functionality being largely and satisfactorily retained.

The invention therefore makes it possible to produce glazing with antisoiling photocatalytic coatings that can be toughened and are of high activity, under the optimum industrial conditions, with light transmission and reflection levels and colorimetric characteristics in transmission and in reflection that can be readily adjusted to the values desired by the user.

1. A method of preparing a material exhibiting photocatalytic properties comprising a coating comprising at least partially crystallized titanium oxide, comprising
heating a transparent or semi-transparent substrate,
wherein the substrate comprises a coating of titanium dioxide on at least a first face of the substrate,
to a temperature greater than 600° C., and
conducting crystallization of the titanium dioxide at the temperature greater than 600° C.
thereby at least partially crystallizing the titanium dioxide and forming the material.

2. The method of claim 1, wherein the temperature is greater than 630° C.

3. The method of claim 1, further comprising a toughening treatment, a bending treatment, or a toughening and a bending treatment carried out on the material.

4. The method of claim 1, wherein the titanium dioxide coating is formed by deposition, wherein the substrate is a glass or glass-ceramic substrate, and wherein the substrate, optionally, has been provided beforehand with one or more functional multilayers, one or more functional layers, or a combination thereof.

5. The method of claim 4, further comprising the deposition, on at least a second face of the substrate, of one or more functional multilayers, one or more functional layers, or a combination thereof.

6. The method of claim 5, wherein the heating and conducting are conducted after the depositions on at least the first and second faces.

7. The method of claim 5, wherein the deposition on the at least first and second faces is carried out by cathode sputtering.

8. The method of claim 7, wherein the deposition on the at least first and second faces is carried out in line simultaneously or almost simultaneously, along substantially identical directions, and in opposite senses.

9. A glass sheet, at least one face of which comprises a coating of a material comprising titanium oxide, wherein the glass sheet is capable of undergoing a heat treatment at above 600° C. while still preserving the photocatalytic activity and the optical quality that are required for antisoiling glazing.

10. The glass sheet as claimed in claim 9, wherein the mean colorimetric variation ΔE in reflection on the coating side induced by the heat treatment at above 600° C. is at most 2.8.

11. A laminated glazing, comprising the glass sheet of claim 9 and at least one additional functional layer, at least one functional multilayer, or a combination thereof.

12. A single or multiple, laminated, monolithic glazing, comprising the material exhibiting photocatalytic properties obtained in accordance with the method of claim 1, wherein the substrate is a constituent glass sheet.

13. The glazing as claimed in claim 12, wherein, beneath the coating of a material exhibiting photocatalytic properties, the at least first face of the substrate comprises at least one layer, and wherein the at least one layer forms a barrier to the migration of alkali metals from the glass liable to result from the application of temperatures in excess of 600° C.

14. The glazing as claimed in claim 12, wherein at least a second face of the continuous glass sheet further comprises one or more functional multilayers, one or more functional layers, or a combination thereof, selected from the group consisting of a thermal control, a low-emissivity multilayer, a layer with an optical functionality, wherein the optical functionality is seleted from the group consisting of antireflection, light radiation filtration, coloration, and scattering, a layer comprising an antisoiling photocatalytic material, a hydrophilic layer, a hydrophobic layer, a network of conductive threads, a conductive layer, an antenna, an antistatic layer, and a combination thereof.

15. The application of glazing of claim 14, wherein the glass sheet comprises at least one property selected from the group consisting of self cleaning, antifogging, anticondensation and antisoiling.

16. The method of claim 1, wherein the least partially crystallized titanium oxide is in anatase form.

17. The method of claim 2, wherein the least partially crystallized titanium oxide is in anatase form.

18. The method of claim 3, wherein the least partially crystallized titanium oxide is in anatase form.

19. The method of claim 4, wherein the least partially crystallized titanium oxide is in anatase form.

20. The method of claim 5, wherein the least partially crystallized titanium oxide is in anatase form.
